(19) United States
(12) Patent Application Publication
(10) Pub. No.: US 2012/0151584 A1
(43) Pub. Date: Jun. 14, 2012

(54) METHOD FOR BLOCKING DENIAL-OF-SERVICE ATTACK

(75) Inventors: Byoung-Koo KIM, Daejeon (KR); Seung-Yong Yoon, Daejeon (KR)

(73) Assignee: Electronics and Telecommunications Research Institute, Daejeon (KR)

(21) Appl. No.: 13/324,313

(22) Filed: Dec. 13, 2011

(30) Foreign Application Priority Data
Dec. 14, 2010 (KR) 10-2010-0127820

(51) Int. Cl. G06F 21/00

(52) U.S. Cl. 726/23

(57) ABSTRACT

Disclosed herein is a method for blocking a Denial-of-Service (DoS) attack. A server extracts a plurality of suspicious packets including data, length of which is equal to or greater than a preset length, from a plurality of received packets. The server determines a packet, which includes data composed of characters or character strings identical to each other, among the plurality of suspicious packets, to be an attack packet. The server blocks a packet corresponding to the attack packet. Accordingly, the present invention can block a DoS attack based on UDP flooding.

### CROSS REFERENCE TO RELATED APPLICATION

This application claims the benefit of Korean Patent Application No. 10-2010-0127820, filed on Dec. 14, 2010, which is hereby incorporated by reference in its entirety into this application.

### BACKGROUND OF THE INVENTION

1. Technical Field

The present invention relates generally to a method for blocking a denial-of-service attack. More particularly, the present invention relates to a method for blocking a denial-of-service attack based on user datagram protocol flooding.

2. Description of the Related Art

Generally, Denial-of-Service attacks (hereinafter also referred to as ‘DoS attacks’) are made against websites, domain name servers or the like, and deteriorate the availability of networks or servers. In particular, Distributed Denial-of-Service attacks (hereinafter also referred to as ‘DDoS attacks’) are made in such a way that a plurality of zombie computers infected with malicious code simultaneously make DoS attacks.

User Datagram Protocol (UDP) flooding (hereinafter also referred to as ‘UDP flooding’) is a kind of DDoS attack, and denotes an attack made in such a way as to consume the network resources of targets for attacks using a large number of UDP packets conforming to a User Datagram Protocol (hereinafter also referred to as ‘UDP’).

In the prior art, attacks based on UDP flooding were coped with by detecting attacks based on UDP flooding using traffic measurement and by blocking all of the traffic. However, this method of coping with attacks is problematic in that even the normal traffic of a proper user may be blocked.

### SUMMARY OF THE INVENTION

An object of the present invention is to provide a method for blocking DoS attacks based on the characteristics of the respective types of attack traffic, in particular, UDP flooding attacks.

In accordance with an aspect of the present invention, there is provided a method for blocking a Denial-of-Service (DoS) attack based on User Datagram Protocol (UDP) flooding, including extracting a plurality of suspicious packets including data, length of which is equal to or greater than a preset length, from a plurality of received packets, determining a packet, which includes data composed of characters or character strings identical to each other, among the plurality of suspicious packets, to be an attack packet, and blocking a packet corresponding to the attack packet.

In accordance with another aspect of the present invention, there is provided a method for blocking a Denial-of-Service (DoS) attack based on User Datagram Protocol (UDP) flooding, including determining whether a plurality of received packet fragments include data composed of characters identical to each other, if it is determined that the plurality of packet fragments include the data composed of characters identical to each other, configuring a filtering table that includes filtering data by using header information of each of the plurality of packet fragments, and blocking a packet fragment corresponding to the filtering data using the filtering table.

In accordance with a further aspect of the present invention, there is provided a method for blocking a Denial-of-Service (DoS) attack based on User Datagram Protocol (UDP) flooding, including, if a destination port of a received packet is closed, generating a response message corresponding to the packet so as to indicate that the packet cannot be transferred to the destination port, extracting destination address information and destination port information from the packet, generating filtering data including the destination address information and the destination port information, and blocking an attack packet that includes the destination address information and the destination port information by using the filtering data.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of a client-server system according to an embodiment of the present invention;

FIG. 2 is a flowchart showing a DoS attack method performed by a client according to a first embodiment of the present invention;

FIG. 3 is a diagram showing the structure of a first packet fragment according to a first embodiment of the present invention;

FIG. 4 is a diagram showing the structure of a second packet fragment according to a first embodiment of the present invention;

FIG. 5 is a flowchart showing a method for blocking a DoS attack according to a first embodiment of the present invention;

FIG. 6 is a flowchart showing a filtering data generation method according to a first embodiment of the present invention;

FIG. 7 is a diagram showing the structure of a filtering table according to a first embodiment of the present invention;

FIG. 8 is a flowchart showing a packet filtering method according to a first embodiment of the present invention;

FIG. 9 is a flowchart showing a DoS attack method performed by a client according to a second embodiment of the present invention;

FIG. 10 is a diagram showing the structure of a UDP packet according to a second embodiment of the present invention;

FIG. 11 is a flowchart showing a method for blocking a DoS attack according to a second embodiment of the present invention;

FIG. 12 is a flowchart showing a DoS attack method performed by a client according to a third embodiment of the present invention;

FIG. 13 is a diagram showing the structure of a UDP packet according to a third embodiment of the present invention;

FIG. 14 is a flowchart showing a method for blocking a DoS attack according to a third embodiment of the present invention;

FIG. 15 is a flowchart showing a filtering table configuration method according to a third embodiment of the present invention;

FIG. 16 is a diagram showing the structure of a filtering table according to a third embodiment of the present invention;

FIG. 17 is a flowchart showing a packet filtering method according to a third embodiment of the present invention;

FIG. 18 a flowchart showing a DoS attack method performed by a client according to a fourth embodiment of the present invention;

FIG. 19 is a diagram showing the structure of a UDP packet according to a fourth embodiment of the present invention;

FIG. 20 is a diagram showing the structure of an ICMP message according to a fourth embodiment of the present invention;

FIG. 21 is a flowchart showing a method for blocking a DoS attack according to a fourth embodiment of the present invention;

FIG. 22 is a flowchart showing a filtering table configuration method according to a fourth embodiment of the present invention;

FIG. 23 is a diagram showing the structure of a filtering table according to a fourth embodiment of the present invention;

FIG. 24 is a flowchart showing a packet filtering method according to a fourth embodiment of the present invention;

FIG. 25 is a flowchart showing a DoS attack method performed by a client according to a fifth embodiment of the present invention;

FIG. 26 is a diagram showing the structure of a packet fragment according to a fifth embodiment of the present invention; and

FIG. 27 is a flowchart showing a method for blocking a DoS attack according to a fifth embodiment of the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Hereinafter, a method for blocking a Denial-of-Service (DoS) attack according to embodiments of the present invention will be described with reference to the attached drawings.

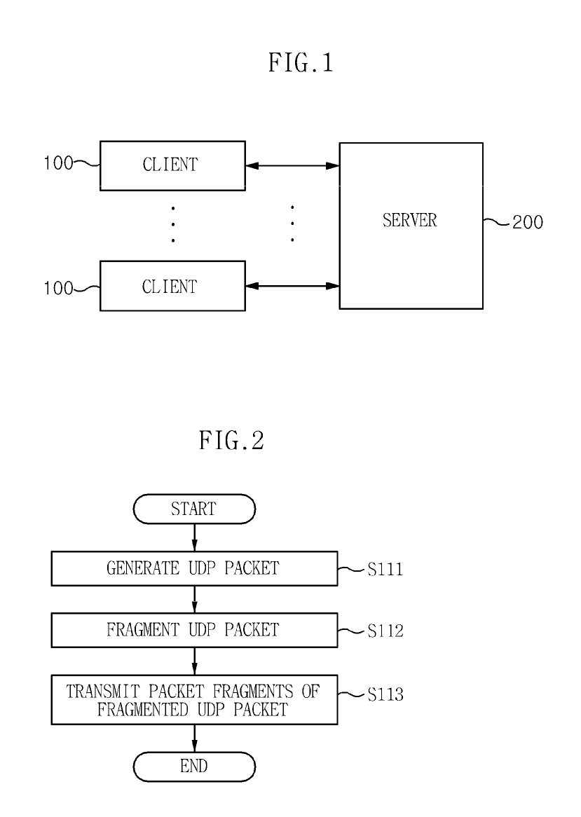

First, a client-server system according to an embodiment of the present invention will now be described with reference to FIG. 1.

FIG. 1 is a diagram showing the construction of a client-server system according to an embodiment of the present invention.

As shown in FIG. 1, the client-server system includes a plurality of clients 100 and a server 200.

The clients 100 are connected to the server 200 and are configured to request principal tasks or information from the server 200 and receive the results the performance thereof from the server 200.

The server 200 returns the results of the performance of the tasks or the information requested by the clients 100.

Next, a method in which a client makes a Denial-of-Service (DoS) attack against a server on the basis of a UDP flooding attack method according to a first embodiment of the present invention will be described with reference to FIG. 2.

FIG. 2 is a flowchart showing a DoS attack method performed by a client according to a first embodiment of the present invention.

As shown in FIG. 2, a client 100 generates a UDP packet for a DoS attack against a server 200 at step S111.

The client 100 fragments the generated UDP packet, and then generates a plurality of packet fragments corresponding to the UDP packet at step S112.

Then, the client 100 transmits the generated packet fragments to the server 200 at step S113.

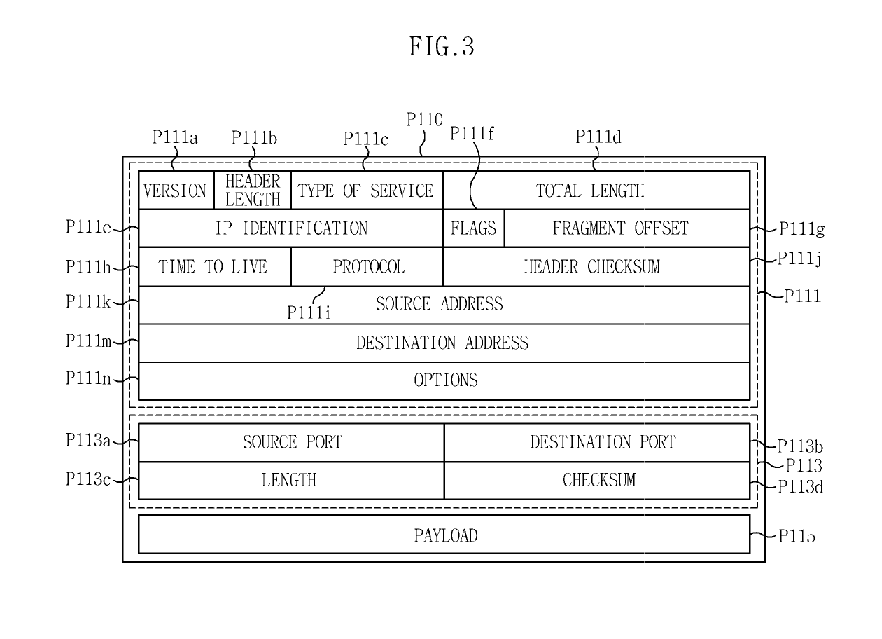

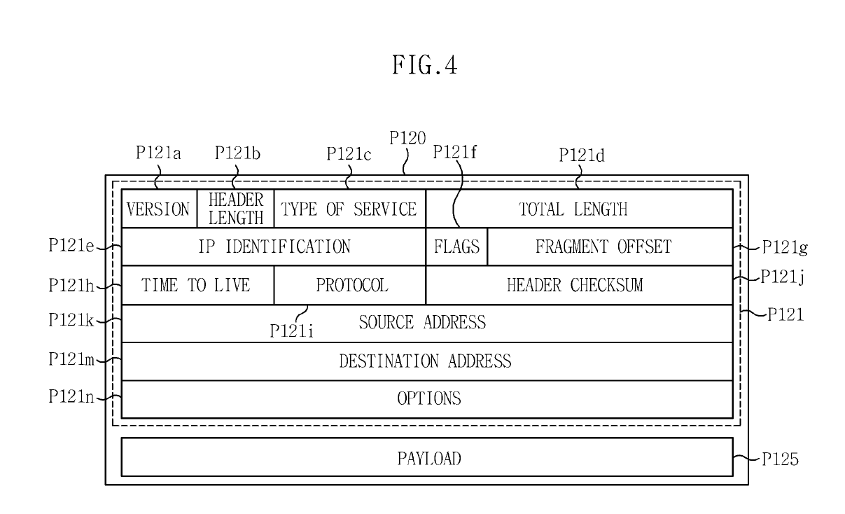

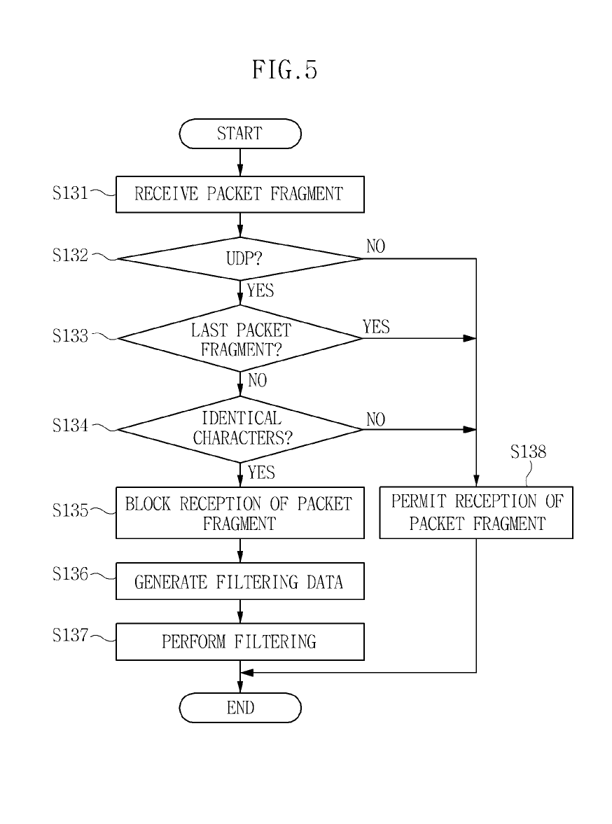

The packet fragments obtained from a fragmented UDP packet according to a first embodiment of the present invention will now be described with reference to FIGS. 3 and 4.

FIG. 3 is a diagram showing the structure of a first packet fragment according to a first embodiment of the present invention.

As shown in FIG. 3, a first packet fragment P110 denotes the first packet fragment of a fragmented UDP packet, and includes an Internet Protocol header (hereinafter also referred to as an ‘IP header’) P111, a UDP header P113, and a payload P115.

The IP header P111 includes a version field (hereinafter also referred to as ‘Version’) P111a, a header length field (hereinafter also referred to as ‘Header Length’) P111b, a service type field (hereinafter also referred to as ‘Type of Service’) P111c, a packet length field (hereinafter also referred to as ‘Total Length’) P111d, an IP identification field (hereinafter also referred to as ‘IP identification’) P111e, a flag field (hereinafter also referred to as ‘Flags’) P111f, a fragment offset field (hereinafter also referred to as ‘Fragment Offset’) P111g, a packet duration field (hereinafter also referred to as ‘Time to Live’) P111h, a protocol identification field (hereinafter also referred to as ‘Protocol’) P111i, a header checksum field (hereinafter also referred to as ‘Header Checksum’) P111j, a source address field (hereinafter also referred to as ‘Source Address’) P111k, a destination address field (hereinafter also referred to as ‘Destination Address’) P111m, and an option field (hereinafter also referred to as ‘Options’) P111n.

The version field (Version) P111a includes a field value indicating the version of an Internet Protocol (hereinafter also referred to as an ‘IP’).

The header length field (Header Length) P111b includes a field value indicating the length of the IP header P111.

The service type field (Type of Service) P111c includes a field value indicating the required service quality.

The packet length field (Total Length) P111d includes a field value indicating the total length of a relevant packet fragment.

The IP identification field (IP Identification) P111e includes a field value indicating the identification information of the IP header P111 of the relevant packet fragment. In this case, the plurality of packet fragments constituting the fragmented UDP packet have the same field value in the IP identification field P111e.

The flag field (Flags) P111f includes a field value indicating fragmentation information about the relevant packet fragment. Here, when the relevant packet fragment is not the last packet fragment of the fragmented UDP packet, the flag field (Flags) P111f may have a field value of “0x1” indicative of “More Fragments.” Further, when the relevant packet fragment is the last packet fragment of the fragmented UDP packet, the flag field (Flags) P111f may have a field value of “0x2” indicative of “No more Fragments.”

The fragment offset field (Fragment Offset) P111g includes a field value indicating the location of the relevant packet fragment in the UDP packet.

The packet duration field (Time To Live) P111h includes a field value indicating the packet duration which is required to determine whether to discard the relevant packet fragment.

The protocol identification field (Protocol) P111i includes a field value indicating the protocol of the relevant packet fragment. Here, when the relevant packet fragment conforms to the UDP, the protocol identification field P111i may have a field value of “0x11.”

The header checksum field (Header Checksum) P111j includes a field value required to detect errors in the IP header P111.

The source address field (Source Address) P111k includes a field value indicating the IP address of a source.

The destination address field (Destination Address) P111m includes a field value indicating the IP address of a destination.

The option field (Options) P111n includes a field value indicating the selection option of the IP header P111.

The UDP header P113 includes a source port field (hereinafter also referred to as a ‘Source Port’) P113a, a destination port field (hereinafter also referred to as a ‘Destination Port’) P113b, a data length field (hereinafter also referred to as ‘Length’) P113c, and a checksum field (hereinafter also referred to as ‘Checksum’) P113d.

The source port field (Source Port) P113a includes a field value indicating the port number of the source.

The destination port field (Destination Port) P113b includes a field value indicating the port number of the destination.

The data length field (Length) P113c includes a field value indicating the length of the payload P115.

The checksum field (Checksum) P113d includes a field value required to detect errors in the UDP header P113.

The payload P115 may include data composed of the characters identical to each other. For example, the payload P115 may include data such as “xxxxx” composed of the identical characters “x.”

FIG. 4 is a diagram showing the structure of a second packet fragment according to a first embodiment of the present invention.

As shown in FIG. 4, a second packet fragment P120 is the second packet fragment of the fragmented UDP packet and includes an IP header P121 and a payload P125.

The IP header P121 includes a version field (Version) P121a, a header length field (Header Length) P121b, a service type field (Type of Service) P121c, a packet length field (Total Length) P121d, an IP identification field (IP Identification) P121e, a flag field (Flags) P121f, a fragment offset field (Fragment Offset) P121g, a packet duration field (Time To Live) P121h, a protocol identification field (Protocol) P121i, a header checksum (Header Checksum) P121j, a source address field (Source Address) P121k, a destination address field (Destination Address) P121m, and an option field (Options) P121n.

The version field (Version) P121a includes a field value indicating the version of an Internet protocol (IP).

The header length field (Header Length) P121b includes a field value indicating the length of the IP header P121.

The service type field (Type of Service) P121c includes a field value indicating the required service quality.

The packet length field (Total Length) P121d includes a field value indicating the total length of a relevant packet fragment.

The IP identification field (IP Identification) P121e includes a field value indicating the identification information of the IP header P121 of the relevant packet fragment. Here, the plurality of packet fragments constituting the fragmented UDP packet have the same field value in the IP identification field P121e.

The flag field (Flags) P121f includes a field value indicating fragmentation information about the relevant packet fragment. Here, when the relevant packet fragment is not the last packet fragment of the fragmented UDP packet, the flag field (Flags) P121f may have a field value of “0x1” indicative of “More Fragments.” Further, when the relevant packet fragment is the last packet fragment of the fragmented UDP packet, the flag field P121f may have a field value of “0x2” indicative of “No more Fragments.”

The fragment offset field (Fragment Offset) P121g includes a field value indicating the location of the relevant packet fragment in the UDP packet.

The packet duration field (Time To Live) P121h includes a field value indicating the packet duration required to determine whether to discard the relevant packet fragment.

The protocol identification field (Protocol) P121i includes a field value indicating the protocol of the relevant packet fragment. In this case, when the relevant packet fragment conforms to UDP, the protocol identification field (Protocol) P121i may have a field value of “0x11.”

The header checksum (Header Checksum) P121j includes a field value required to detect errors in the IP header P121.

The source address field (Source Address) P121k includes a field value indicating the IP address of a source.

The destination address field (Destination Address) P121m includes a field value indicating the IP address of a destination.

The option field (Options) P121n includes a field value indicating the selection option of the IP header P121.

The payload P125 may include data composed of the characters identical to each other. For example, the payload P125 may include data such as “xxxxx” composed of the identical characters “x.”

Next, a method in which the server blocks a DoS attack made by the client according to a first embodiment of the present invention will be described with reference to FIG. 5.

FIG. 5 is a flowchart showing a method for blocking a DoS attack according to a first embodiment of the present invention.

As shown in FIG. 5, the server 200 receives a packet fragment from the client 100 at step S131.

The server 200 sets the protocol of the received packet fragment according to the field value of the protocol identification field in the IP header of the received packet fragment, and then determines whether the protocol of the received packet fragment is UDP at step S132.

If it is determined that the protocol of the received packet fragment is UDP, the server 200 determines whether the received packet fragment is the last packet fragment of a plurality of packet fragments, generated by the fragmentation of a single UDP packet, on the basis of the field value of the flag field (Flags) in the IP header of the received packet fragment at step S133.

If it is determined that the received packet fragment is not the last packet fragment, the server 200 determines whether the payload of the received packet fragment includes data composed of the characters identical to each other at step S134.

If it is determined that the payload of the received packet fragment includes data composed of the characters identical to each other, the server 200 blocks the reception of the packet fragment at step S135. In this case, the server 200 determines that the received packet fragment has caused a load on the server 200.

Thereafter, the server 200 generates filtering data required to block a packet fragment, the field value of the IP identification field of the IP header of which is identical to that of the blocked packet fragment, using the IP header of the blocked packet fragment at step S136.

The server 200 performs filtering on packet fragments, which are subsequently received, using the generated filtering data at step S137.

Further, if the protocol of the received packet fragment is not UDP, the server 200 permits the reception of the packet fragment at step S138.

Meanwhile, if the received packet fragment is the last packet fragment, the server 200 permits the reception of the packet fragment at step S138.

Meanwhile, if the payload of the received packet fragment does not include data composed of the characters identical to each other, the server 200 permits the reception of the packet fragment at step S138.

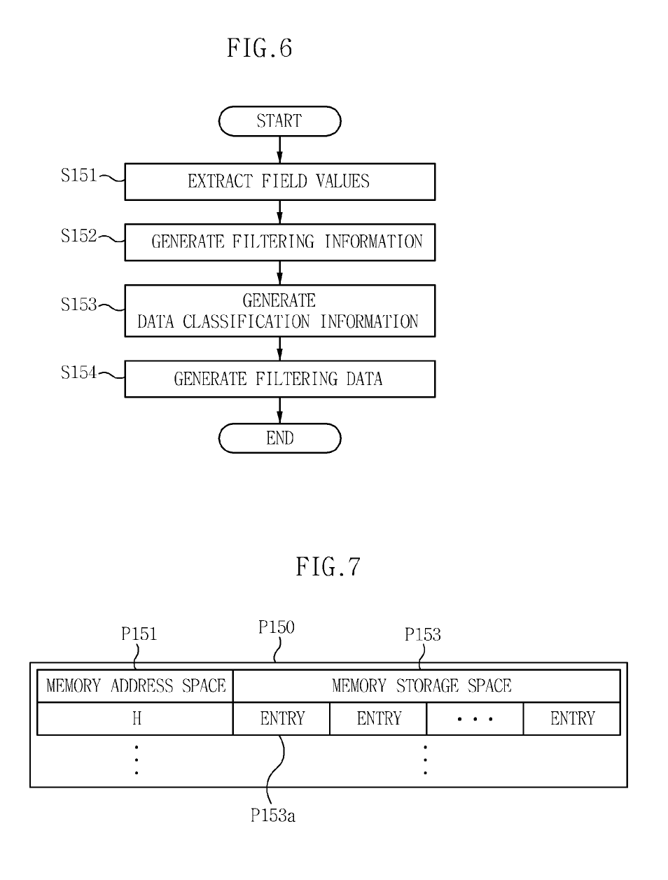

A method in which the server generates filtering data according to a first embodiment of the present invention will be described with reference to FIG. 6.

FIG. 6 is a flowchart showing a filtering data generation method according to a first embodiment of the present invention.

As shown in FIG. 6, the server 200 extracts the field value of the IP identification field, the field value of the source address field, and the field value of the destination address field from the IP header of the blocked packet fragment at step S151.

Next, the server 200 generates filtering information using the extracted field values of the IP identification field, the source address field, and the destination address field at step S152. Here, the filtering information may include the extracted field values of the IP identification field, the source address field, and the destination address field. Further, the filtering information may include hash values, generated by applying the field value of the source address field and the field value of the destination address field to a hash function, and the field value of the IP identification field.

Thereafter, the server 200 generates data classification information corresponding to the filtering information using the field value of the source address field and the field value of the destination address field at step S153. Here, the data classification information may include hash values generated by applying the field value of the source address field and the field value of the destination address field to a hash function.

Next, the server 200 generates filtering data including both the generated data classification information and the generated filtering information at step S154. In this case, the server 200 may store the generated filtering data in a filtering table.

Next, a filtering table according to a first embodiment of the present invention will be described in detail with reference to FIG. 7.

FIG. 7 is a diagram showing the structure of a filtering table according to a first embodiment of the present invention.

As shown in FIG. 7, a filtering table P150 stores filtering data and includes a memory address space P151 and a memory storage space P153.

The memory address space P151 includes field values indicating the data classification information of the filtering data. For example, the memory address space P151 may include hash values, that is, “h” included in the data classification information of the filtering data.

The memory storage space P153 includes entries for storing the filtering information corresponding to the field values of the memory address space P151. For example, the memory storage space P153 may include a plurality of entries P153a corresponding to the field values of the memory address space P151, that is, “h.”

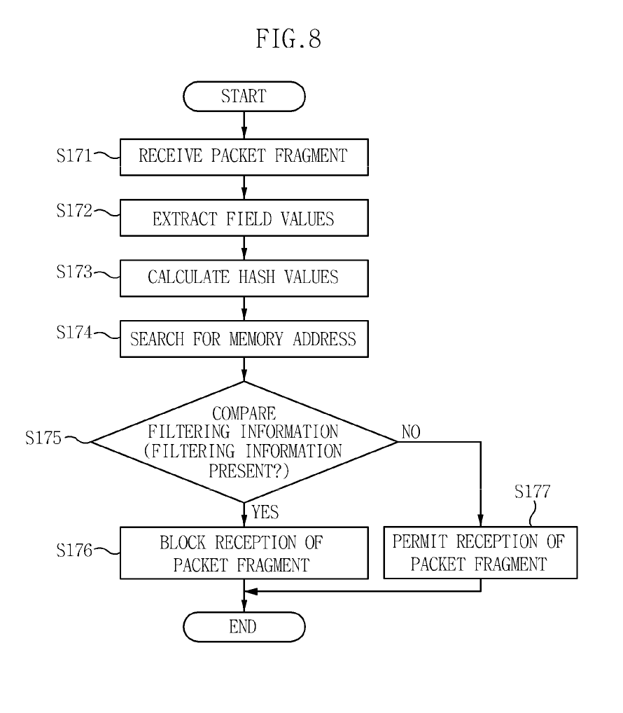

Next, a method in which the server performs filtering on packet fragments using the filtering table according to a first embodiment of the present invention will be described with reference to FIG. 8.

FIG. 8 is a flowchart showing a packet filtering method according to a first embodiment of the present invention.

As shown in FIG. 8, the server 200 receives a packet fragment from the client 100 at step S171.

The server 200 extracts a plurality of field values, that is, the field value of an IP identification field, the field value of a source address field, and the field value of a destination address field from the IP header of the received packet fragment at step S172.

The server 200 calculates hash values by applying the field values of the source address field and the destination address field, among the plurality of extracted field values, to a hash function at step S173.

The server 200 searches the memory address space P151 of the pre-stored filtering table P150 for the field values of the memory address space P151 corresponding to the calculated hash values at step S174.

The server 200 compares pieces of filtering information respectively stored in the plurality of entries corresponding to the detected field values of the memory address space P151 with the plurality of extracted field values, and then determines whether pieces of filtering information corresponding to the plurality of extracted field values are present at step S175.

If it is determined that pieces of filtering information corresponding to the extracted field values are present, the server 200 blocks the reception of the packet fragment at step S176.

In contrast, if it is determined that pieces of filtering information corresponding to the extracted field values are not present, the server 200 permits the reception of the packet fragment at step S177.

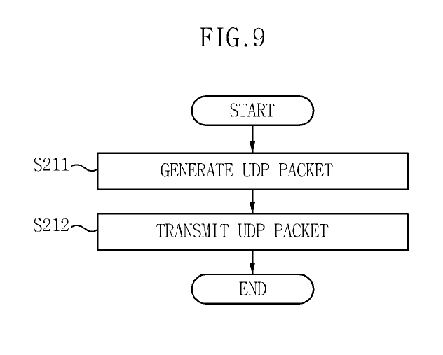

Next, a method in which the client makes a DoS attack against the server on the basis of a UDP flooding attack method according to a second embodiment of the present invention will be described with reference to FIG. 9.

FIG. 9 is a flowchart showing a DoS attack method performed by the client according to a second embodiment of the present invention.

As shown in FIG. 9, the client 100 generates a UDP packet for a DoS attack against the server 200 at step S211.

The client 100 transmits the generated UDP packet to the server 200 at step S212.

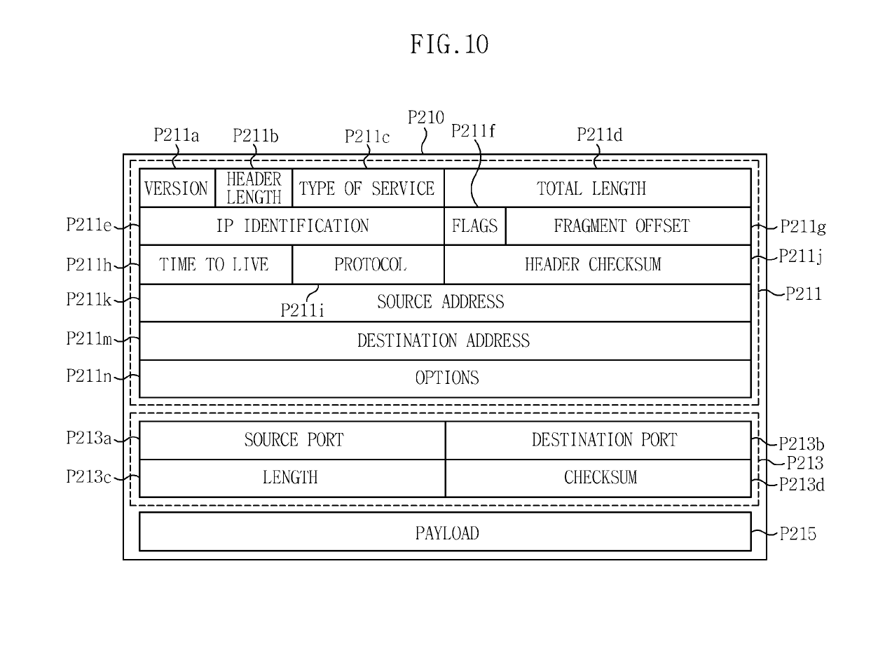

Next, a UDP packet according to a second embodiment of the present invention will be described with reference to FIG. 10.

FIG. 10 is a diagram showing the structure of a UDP packet according to a second embodiment of the present invention.

As shown in FIG. 10, a UDP packet P210 includes an IP header P211, a UDP header P213, and a payload P215.

The IP header P211 includes a version field (Version) P211a, a header length field (Header Length) P211b, a service type field (Type of Service) P211c, a packet length field (Total Length) P211d, an IP identification field (IP Identification) P211e, a flag field (Flags) P211f, a fragment offset field (Fragment Offset) P211g, a packet duration field (Time To Live) P211h, a protocol identification field (Protocol) P211i, a header checksum field (Header Checksum) P211j, a source address field (Source Address) P211k, a destination address field (Destination Address) P211m, and an option field (Options) P211n.

The version field (Version) P211a includes a field value indicating the version of an Internet protocol (IP).

The header length field (Header Length) P211b includes a field value indicating the length of the IP header P211.

The service type field (Type of Service) P211c includes a field value indicating the required service quality.

The packet length field (Total Length) P211d includes a field value indicating the total length of a relevant packet.

The IP identification field (IP Identification) P211e includes a field value indicating the identification information of the IP header P211 of the relevant packet.

The flag field (Flags) P211f includes a field value indicating fragmentation information about the relevant packet.

The fragment offset field (Fragment Offset) P211g includes a field value indicating the location of each packet fragment obtained from fragmentation when the relevant packet is fragmented.

The packet duration field (Time To Live) P211h includes a field value indicating the packet duration required to determine whether to discard the relevant packet.

The protocol identification field (Protocol) P211i includes a field value indicating the protocol of the relevant packet. In this case, when the relevant packet conforms to UDP, the protocol identification field (Protocol) P211i may have a field value of “0x11.”

The header checksum (Header Checksum) P211j may include a field value required to detect errors in the IP header P211.

The source address field (Source Address) P211k includes a field value indicating the IP address of a source.

The destination address field (Destination Address) P211m includes a field value indicating the IP address of a destination.

The option field (Options) P211n includes a field value indicating the selection option of the IP header P211.

The UDP header P213 includes a source port field (Source Port) P213a, a destination port field (Destination Port) P213b, a data length field (Length) P213c, and a checksum field (Checksum) P213d.

The source port field (Source Port) P213a includes a field value indicating the port number of the source.

The destination port field (Destination Port) P213b includes a field value indicating the port number of the destination.

The data length field (Length) P213c includes a field value indicating the length of the payload P215.

The checksum field (Checksum) P213d includes a field value required to detect errors in the UDP header P213.

The payload P215 includes data composed of the characters identical to each other. For example, the payload P215 may include data such as “xxxxx” composed of the identical characters “x.”

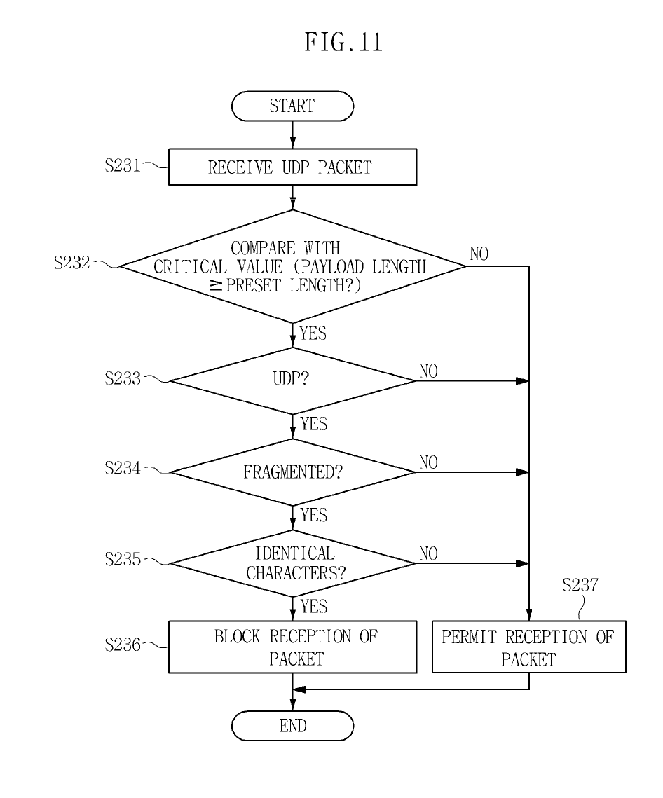

Next, a method in which the server blocks a DoS attack made by the client according to a second embodiment of the present invention will now be described in detail with reference to FIG. 11.

FIG. 11 is a flowchart showing a method for blocking a DoS attack according to a second embodiment of the present invention.

As shown in FIG. 11, the server 200 receives a UDP packet P210 from the client 100 at step S231.

The server 200 compares the field value of the data length field P213c of the UDP header P213 of the received UDP packet P210 with a preset critical value, and then determines whether the length of the payload P215 of the received UDP packet P210 is equal to or greater than a preset length at step S232. Here, the preset length may be designated as 64 bytes.

If the length of the payload P215 is equal to or greater than the preset length, the server 200 sets the protocol of the received UDP packet P210 according to the field value of the protocol identification field P211i of the IP header P211 of the received UDP packet P210, and then determines whether the protocol of the received UDP packet P210 is a User Datagram Protocol (UDP) at step S233.

If it is determined that the protocol of the received UDP packet P210 is UDP, the server 200 determines whether the received UDP packet P210 has been fragmented, on the basis of the field values of the flag field (Flags) P211f and the fragment offset field P211g of the IP header P211 of the received UDP packet P210 at step S234.

If it is determined that the received UDP packet P210 has not been fragmented, the server 200 determines whether the payload 215 of the received UDP packet P210 includes data composed of the characters identical to each other at step S235.

If the payload P215 of the received UDP packet P210 includes data composed of the characters identical to each other, the server 200 blocks the reception of the UDP packet P210 at step S236.

Further, if the length of the payload P215 is less than the preset length, the server 200 permits the reception of the UDP packet P210 at step S237.

Meanwhile, if the protocol of the received UDP packet P210 is not UDP, the server 200 permits the reception of the UDP packet P210 at step S237.

Furthermore, if the received UDP packet P210 has been fragmented, the server 200 permits the reception of the UDP packet P210 at step S237.

Meanwhile, if the payload P215 of the received UDP packet P210 does not include data composed of the characters identical to each other, the server 200 permits the reception of the UDP packet P210 at step S237.

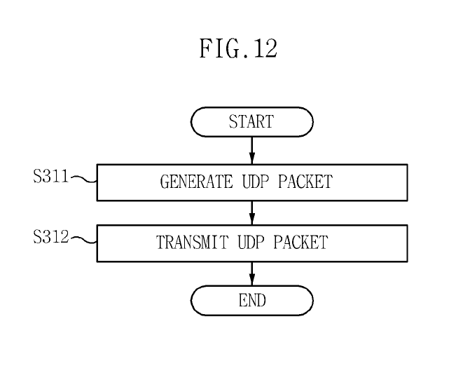

Next, a method in which the client makes a DoS attack against the server on the basis of a UDP flooding attack method according to a third embodiment of the present invention will be described in detail with reference to FIG. 12.

FIG. 12 is a flowchart showing a DoS attack method performed by the client according to a third embodiment of the present invention.

As shown in FIG. 12, the client 100 generates a UDP packet for a DoS attack against the server 200 at step S311.

Thereafter, the client 100 transmits the generated UDP packet to the server 200 at step S312.

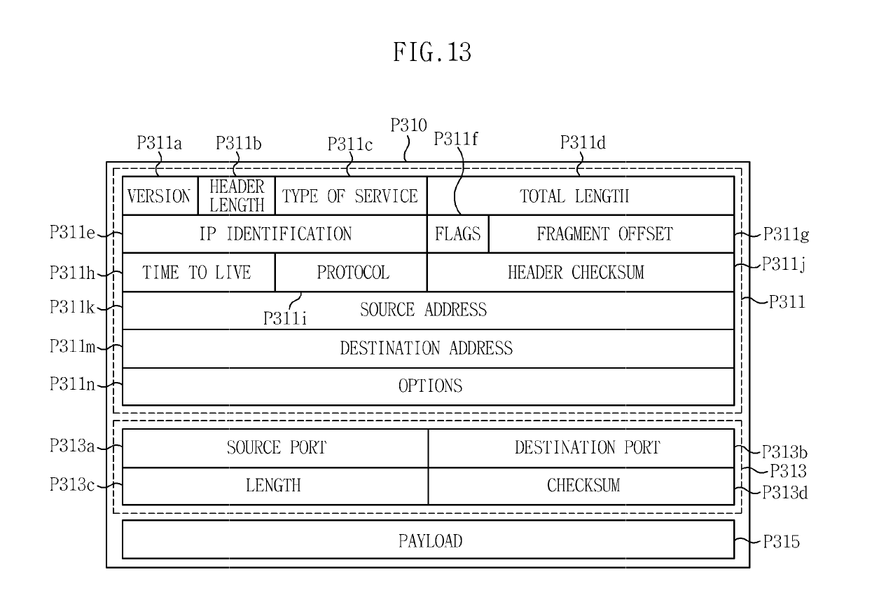

A UDP packet according to a third embodiment of the present invention will be described with reference to FIG. 13.

FIG. 13 is a diagram showing the structure of a UDP packet according to a third embodiment of the present invention.

As shown in FIG. 13, a UDP packet P310 includes an IP header P311, a UDP header P313, and a payload P315.

The IP header P311 includes a version field (Version) 311a, a header length field (Header Length) P311b, a service type field (Type of Service) P311c, a packet length field (Total Length) P311d, an IP identification field (IP Identification) P311e, a flag field (Flags) P311f, a fragment offset field (Fragment Offset) P311g, a packet duration field (Time To Live) P311h, a protocol identification field (Protocol) P311i, a header checksum field (Header Checksum) P311j, a source address field (Source Address) P311k, a destination address field (Destination Address) P311m, and an option field (Options) P311n.

The version field (Version) P311a includes a field value indicating the version of an Internet Protocol (IP).

The header length field (Header Length) P311b includes a field value indicating the length of the IP header P311.

The service type field (Type of Service) P311c includes a field value indicating required service quality.

The packet length field (Total Length) P311d includes a field value indicating the total length of a relevant packet.

The IP identification field (IP Identification) P311e includes a field value indicating the identification information of the IP header P311 of the relevant packet.

The flag field (Flags) P311f includes a field value indicating fragmentation information about the relevant packet.

The fragment offset field (Fragment Offset) P311g includes a field value indicating the location of each packet fragment obtained from fragmentation when the relevant packet is fragmented.

The packet duration field (Time To Live) P311h includes a field value indicating the packet duration required to determine whether to discard the relevant packet.

The protocol identification field (Protocol) P311i includes a field value indicating the protocol of the relevant packet. In this case, when the relevant packet conforms to UDP, the protocol identification field (Protocol) P311i may have a field value of “0x11.”

The header checksum (Header Checksum) P311j may include a field value required to detect errors in the IP header P311.

The source address field (Source Address) P311k includes a field value indicating the IP address of a source.

The destination address field (Destination Address) P311m includes a field value indicating the IP address of a destination.

The option field (Options) P311n includes a field value indicating the selection option of the IP header P311.

The UDP header P313 includes a source port field (Source Port) P313a, a destination port field (Destination Port) P313b, a data length field (Length) P313c, and a checksum field (Checksum) P313d.

The source port field (Source Port) P313a includes a field value indicating the port number of the source.

The destination port field (Destination Port) P313b includes a field value indicating the port number of the destination.

The data length field (Length) P313c includes a field value indicating the length of the payload P315.

The checksum field (Checksum) P313d includes a field value required to detect errors in the UDP header P313.

The payload P315 includes data implemented as any character string. For example, the payload P315 may include data implemented as any character string, such as “abcdef . . . ”

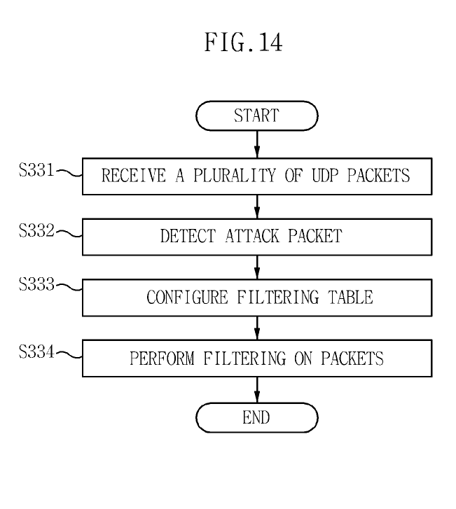

Next, a method in which the server blocks a DoS attack made by the client according to a third embodiment of the present invention will be described in detail with reference to FIG. 14.

FIG. 14 is a flowchart showing a method for blocking a DoS attack according to a third embodiment of the present invention.

As shown in FIG. 14, the server 200 receives a plurality of UDP packets at step S331.

Next, the server 200 determines a UDP packet, which includes data composed of the character strings identical to each other in the payload thereof among the plurality of received UDP packets, to be an attack packet, and then detects the attack packet at step S332.

Thereafter, the server 200 configures a filtering table using the determined attack packet at step S333.

Next, the server 200 performs filtering on UDP packets, which are subsequently received, using the filtering table at step S334.

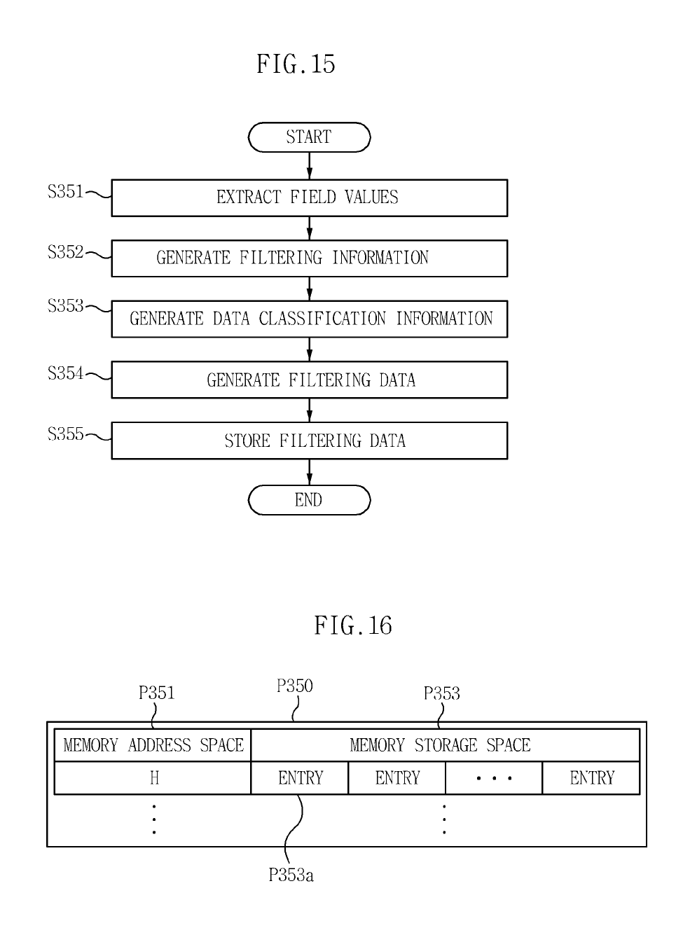

A method in which the server configures the filtering table according to a third embodiment of the present invention will be described with reference to FIG. 15.

FIG. 15 is a flowchart showing a filtering table configuration method according to a third embodiment of the present invention.

As shown in FIG. 15, the server 200 extracts a plurality of field values, that is, the field value of a source address field P311k, the field value of a destination address field P311m, and the field value of a data length field P313c, from the IP header P311 and the UDP header P313 of a UDP packet P310 corresponding to an attack packet at step S351.

The server 200 generates filtering information about the attack packet using the payload P315 of the UDP packet P310 and the extracted field values at step S352. Here, the filtering information includes the field value of a data length field (Length) P313c and the hash value of the payload P315. The hash value of the payload 315 can be generated by applying data included in the payload P315 to a hash function. The filtering information may further include the field value of the source address field 311k and the field value of the destination address field P311m, and may also include hash values generated by applying the field values of the source address field P311k and the destination address field P311m to a hash function.

Thereafter, the server 200 generates data classification information corresponding to the filtering information using the field values of the source address field and the destination address field at step S353. Here, the data classification information may include hash values generated by applying the field values of the source address field P311k and the destination address field P311m to a hash function.

The server 200 generates filtering data including the generated data classification information and the filtering information at step S354.

The server 200 stores the generated filtering data in a filtering table at step S355.

Next, a filtering table according to a third embodiment of the present invention will be described with reference to FIG. 16.

FIG. 16 is a diagram showing the structure of a filtering table according to a third embodiment of the present invention.

As shown in FIG. 16, a filtering table P350 stores filtering data, and includes a memory address space P351 and a memory storage space P353.

The memory address space P351 includes field values indicating the data classification information of the filtering data. For example, the memory address space P351 may include hash values, that is, “h” included in the data classification information of the filtering data.

The memory storage space P353 includes entries for storing the filtering information corresponding to the field values of the memory address space P351. For example, the memory storage space P353 may include a plurality of entries P353a corresponding to the field values of the memory address space P351, that is, “h.”

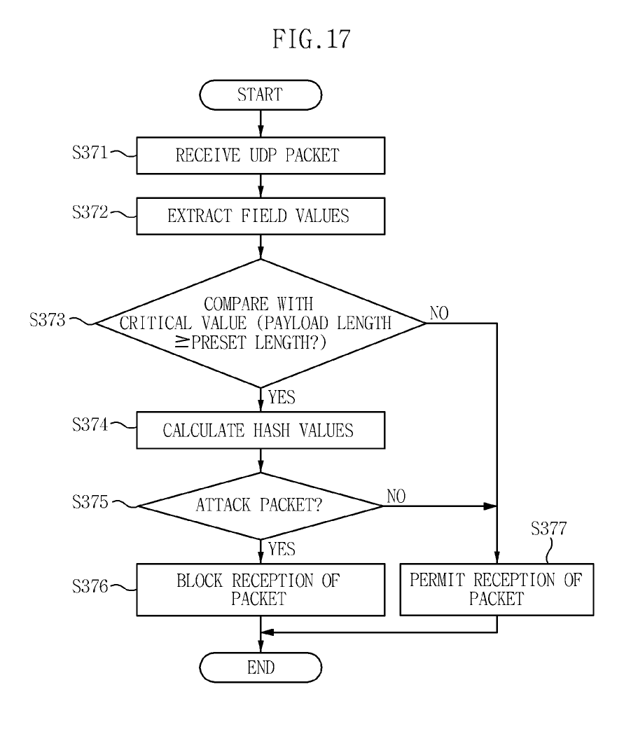

Next, a method in which the server performs filtering on packets using the filtering table according to a third embodiment of the present invention will be described with reference to FIG. 17.

FIG. 17 is a flowchart showing a packet filtering method according to a third embodiment of the present invention.

As shown in FIG. 17, the server 200 receives a UDP packet P310 from the client 100 at step S371.

The server 200 extracts the field value of a data length field (Length) P313c from the UDP header P313 of the received UDP packet P310 at step S372.

The server 200 compares the extracted field value of the data length field P313c with a preset critical value, and then determines whether the length of the payload P315 of the received UDP packet P310 is equal to or greater than a preset length at step S373. That is, The server 200 extracts a plurality of suspicious packets including data, length of which is equal to or greater than a preset length, from a plurality of received UDP packets P310. Here, the preset length may be designated as 64 bytes.

If the length of the payload P315 is equal to or greater than the preset length, the server 200 calculates a hash value of the payload P315 of the received UDP packet P310 at step S374. In this case, the hash value of the payload P315 may be generated by applying data included in the payload P315 to a hash function.

The server 200 determines whether the received UDP packet P310 is an attack packet by using the calculated hash value of the payload P315 and the extracted field value of the data length field P313c at step S375. That is, The server 200 determines a packet, which includes data composed of characters or character strings identical to each other, among the plurality of suspicious packets, to be an attack packet. In this case, the server 200 can determine the received packet to be an attack packet when the filtering data corresponding to the calculated hash value of the payload P315 and the extracted field value of the data length field P313c is stored in the filtering table P350.

If the received UDP packet P310 is an attack packet, the server 200 blocks the reception of the UDP packet P310 at step S376.

Meanwhile, if the length of the payload P315 is less than the preset length, the server 200 permits the reception of the UDP packet P310 at step S377.

Meanwhile, if the received UDP packet P310 is not an attack packet, the server 200 permits the reception of the UDP packet P310 at step S377.

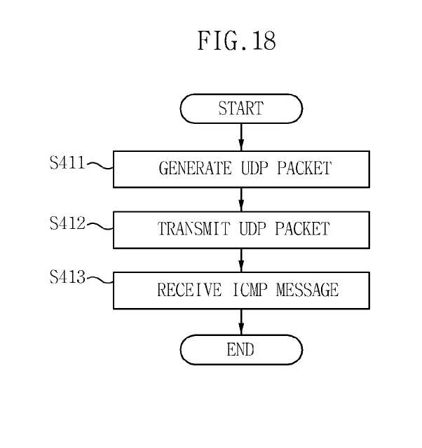

Next, a method in which the client makes a DoS attack against the server on the basis of a UDP flooding attack method according to a fourth embodiment of the present invention will be described with reference to FIG. 18.

FIG. 18 is a flowchart showing a DoS attack method performed by the client according to a fourth embodiment of the present invention.

As shown in FIG. 18, the client 100 generates a UDP packet for a DoS attack against the server 200 at step S411.

The client 100 transmits the generated UDP packet to any service port of the server 200 at step S412.

Thereafter, the client 100 receives an Internet Control Message Protocol message (hereinafter also referred to as an ‘ICMP message’) from the server 200 at step S413.

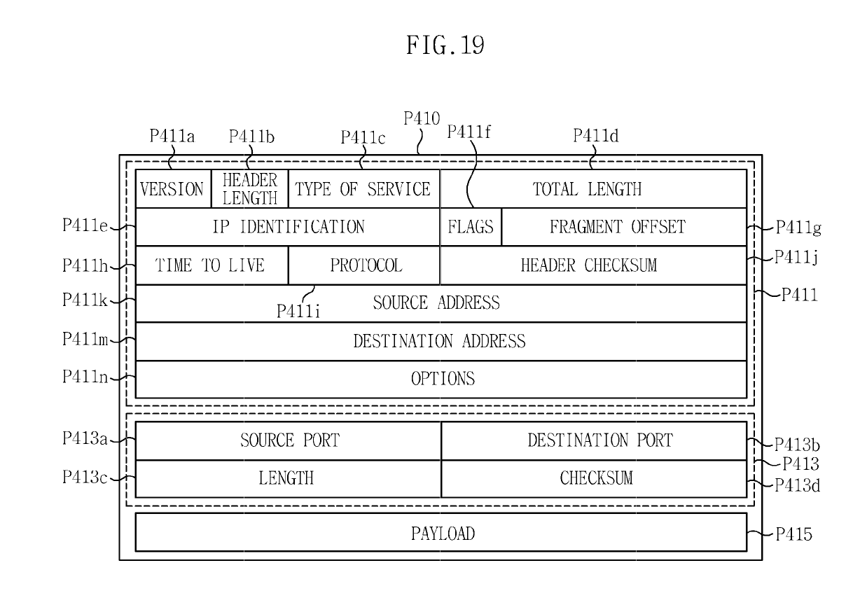

Next, a UDP packet according to a fourth embodiment of the present invention will be described with reference to FIG. 19.

FIG. 19 is a diagram showing the structure of a UDP packet according to a fourth embodiment of the present invention.

As shown in FIG. 19, a UDP packet P410 includes an IP header P411, a UDP header P413, and a payload P415.

The IP header P411 includes a version field (Version) P411a, a header length field (Header Length) P411b, a service type field (Type of Service) P411c, a packet length field (Total Length) P411d, an IP identification field (IP Identification) P411e, a flag field (Flags) P411f, a fragment offset field (Fragment Offset) P411g, a packet duration field (Time To Live) P411h, a protocol identification field (Protocol) P411i, a header checksum field (Header Checksum) P411j, a source address field (Source Address) P411k, a destination address field (Destination Address) P411m, and an option field (Options) P411n.

The version field (Version) P411a includes a field value indicating the version of an Internet protocol (IP).

The header length field (Header Length) P411b includes a field value indicating the length of the IP header P411.

The service type field (Type of Service) P411c includes a field value indicating the required service quality.

The packet length field (Total Length) P411d includes a field value indicating the total length of a relevant packet.

The IP identification field (IP Identification) P411e includes a field value indicating the identification information of the IP header P411 of the relevant packet.

The flag field (Flags) P411f includes a field value indicating fragmentation information about the relevant packet.

The fragment offset field (Fragment Offset) P411g includes a field value indicating the location of each packet fragment obtained from fragmentation when the relevant packet is fragmented.

The packet duration field (Time To Live) P411h includes a field value indicating the packet duration required to determine whether to discard the relevant packet.

The protocol identification field (Protocol) P411i includes a field value indicating the protocol of the relevant packet. In this case, when the relevant packet conforms to UDP, the protocol identification field (Protocol) P411i may have a field value of “0x11.”

The header checksum (Header Checksum) P411j may include a field value required to detect errors in the IP header P411.

The source address field (Source Address) P411k includes a field value indicating the IP address of a source.

The destination address field (Destination Address) P411m includes a field value indicating the IP address of a destination.

The option field (Options) P411n includes a field value indicating the selection option of the IP header P411.

The UDP header P413 includes a source port field (Source Port) P413a, a destination port field (Destination Port) P413b, a data length field (Length) P413c, and a checksum field (Checksum) P413d.

The source port field (Source Port) P413a includes a field value indicating the port number of the source.

The destination port field (Destination Port) P413b includes a field value indicating the port number of the destination.

The data length field (Length) P413c includes a field value indicating the length of the payload P415.

The checksum field (Checksum) P413d includes a field value required to detect errors in the UDP header P413.

The payload P415 includes any type of data.

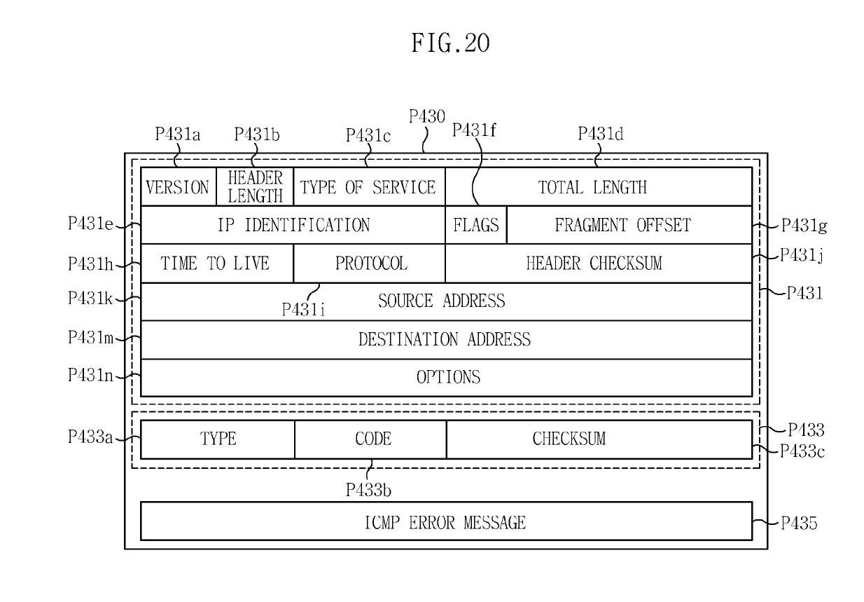

Next, an ICMP message according to a fourth embodiment of the present invention will now be described with reference to FIG. 20.

FIG. 20 is a diagram showing the structure of an ICMP message according to a fourth embodiment of the present invention.

As shown in FIG. 20, a response message P430 includes an IP header P431, an Internet Control Message Protocol header (hereinafter also referred to as an ‘ICMP header’) P433, and an Internet Control Message Protocol error message (hereinafter also referred to as an ‘ICMP error message’) P435.

The IP header P431 includes a version field (Version) P431a, a header length field (Header Length) P431b, a service type field (Type of Service) P431c, a packet length field (Total Length) P431d, an IP identification field (IP Identification) P431e, a flag field (Flags) P431f, a fragment offset field (Fragment Offset) P431g, a packet duration field (Time To Live) P431h, a protocol identification field (Protocol) P431i, a header checksum field (Header Checksum) P431j, a source address field (Source Address) P431k, a destination address field (Destination Address) P431m, and an option field (Options) P431n.

The version field (Version) P431a includes a field value indicating the version of Internet protocol (IP).

The header length field (Header Length) P431b includes a field value indicating the length of the IP header P431.

The service type field (Type of Service) P431c includes a field value indicating the required service quality.

The packet length field (Total Length) P431d includes a field value indicating the total length of a relevant packet.

The IP identification field (IP Identification) P431e includes a field value indicating the identification information of the IP header P431 of the relevant packet.

The flag field (Flags) P431f includes a field value indicating fragmentation information about the relevant packet.

The fragment offset field (Fragment Offset) P431g includes a field value indicating the location of each packet fragment obtained from fragmentation when the relevant packet is fragmented.

The packet duration field (Time To Live) P431h includes a field value indicating the packet duration required to determine whether to discard the relevant packet.

The protocol identification field (Protocol) P431i includes a field value indicating the protocol of a relevant packet. Here, when the relevant packet conforms to an Internet Control Message Protocol (hereinafter also referred to as an ‘ICMP’), the protocol identification field (Protocol) P431i may have a field value of “0x01.”

The header checksum P431j includes a field value required to detect errors in the IP header P431.

The source address field (Source Address) P431k includes a field value indicating the IP address of a source.

The destination address field P431m includes a field value indicating the IP address of a destination.

The option field (Options) P431n includes a field value indicating the selection option of the IP header P431.

The ICMP header P433 includes a type field (hereinafter also referred to as ‘Type’) P433a, a code field (hereinafter also referred to as ‘Code’) P433b, and a checksum field (Checksum) P433c.

The type field (Type) P433 a includes a field value indicating a message type. Here, when the message type is ‘destination unreachable’, the type field P433a may have a field value of “0x3.”

The code field (Code) P433b includes a field value indicating additional detailed information about the message type. Here, when the additional detailed information about the message type is ‘port unreachable’, the code field P433b may have a field value of “0x3.”

The checksum field (Checksum) P433c includes a field value required to detect errors in the ICMP header P433.

The ICMP error message P435 may include the IP header P411 and the UDP header P413 of the UDP packet P410.

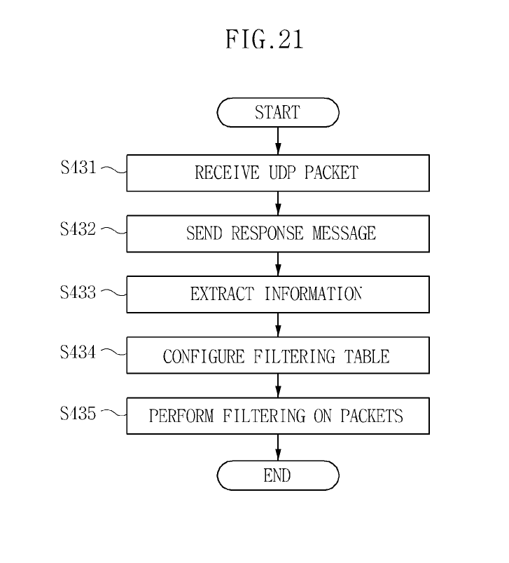

Next, a method in which the server blocks a DoS attack made by the client according to a fourth embodiment of the present invention will now be described in detail with reference to FIG. 21.

FIG. 21 is a flowchart showing a method for blocking a DoS attack according to a fourth embodiment of the present invention.

As shown in FIG. 21, the server 200 receives a UDP packet P410 from the client 100 at step S431.

When the destination port of the received UDP packet P410 is closed, the server 200 sends a response message P430, indicating that the packet cannot be transferred to the destination, to the client 100 at step S432. The response message P430 may be an ICMP message. That is, a protocol of the response message may be ICMP. Further, the response message may have a message type which is a destination unreachable type.

The server 200 extracts destination address information and destination port information from the UDP packet P410, for which the sent ICMP message P430 has been generated, at step S433.

The server 200 configures a filtering table required to filter UDP packets that are transferred via the extracted destination address information and destination port information at step S434.

Thereafter, the server 200 performs filtering on UDP packets, which are subsequently received, using the filtering table at step S435.

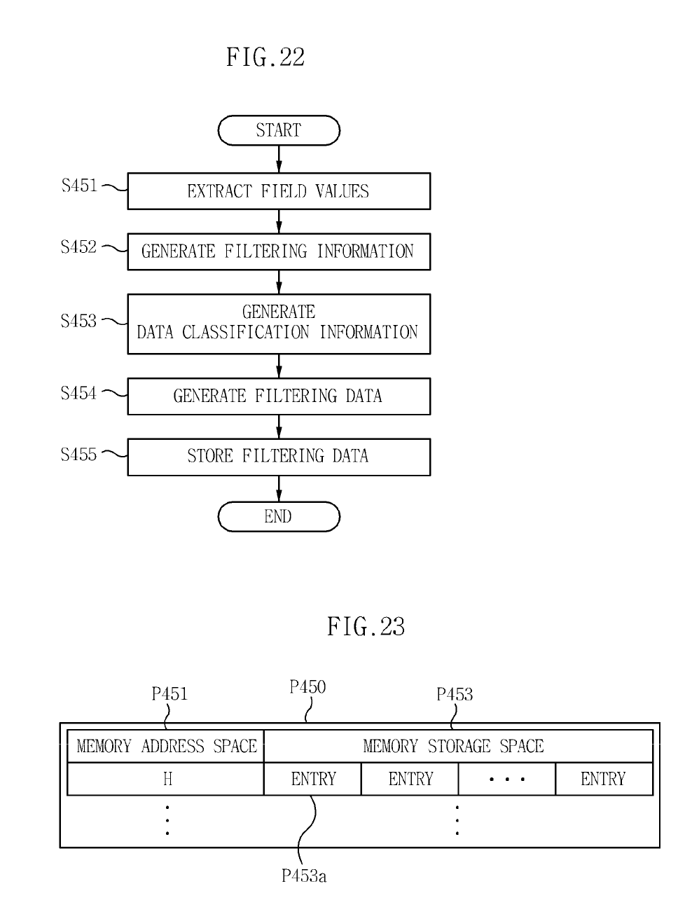

Next, a method in which the server configures the filtering table according to a fourth embodiment of the present invention will be described in detail with reference to FIG. 22.

FIG. 22 is a flowchart showing a filtering table configuration method according to a fourth embodiment of the present invention.

As shown in FIG. 22, the server 200 extracts the field values of a destination address field (Destination Address) P411m and a destination port field (Destination Port) P413b from a UDP packet P410 for which a response message P430 has been generated, at step S451.

The server 200 generates filtering information using the extracted field values of the destination address field P411m and the destination port field P413b at step S452. Here, the filtering information includes the field values of the destination address field P411m and the destination port field P413b.

Thereafter, the server 200 generates data classification information corresponding to the filtering information using the extracted field values of the destination address field P411m and the destination port field P413b at step S453. Here, the data classification information may include hash values generated by applying the field values of the destination address field P411m and the destination port field P413b to a hash function.

The server 200 generates filtering data including the generated data classification information and the generated filtering information at step S454.

Thereafter, the server 200 stores the generated filtering data in a filtering table at step S455.

Next, a filtering table according to a fourth embodiment of the present invention will be described with reference to FIG. 23.

FIG. 23 is a diagram showing the structure of a filtering table according to a fourth embodiment of the present invention.

As shown in FIG. 23, a filtering table P450 stores filtering data, and includes a memory address space P451 and a memory storage space P453.

The memory address space P451 includes field values indicating the data classification information of the filtering data. For example, the memory address space P451 may include hash values, that is, “h” included in the data classification information of the filtering data.

The memory storage space P453 includes entries for storing the filtering information corresponding to the field values of the memory address space P451. For example, the memory storage space P453 may include a plurality of entries P453a corresponding to the field values of the memory address space P451, that is, “h.”

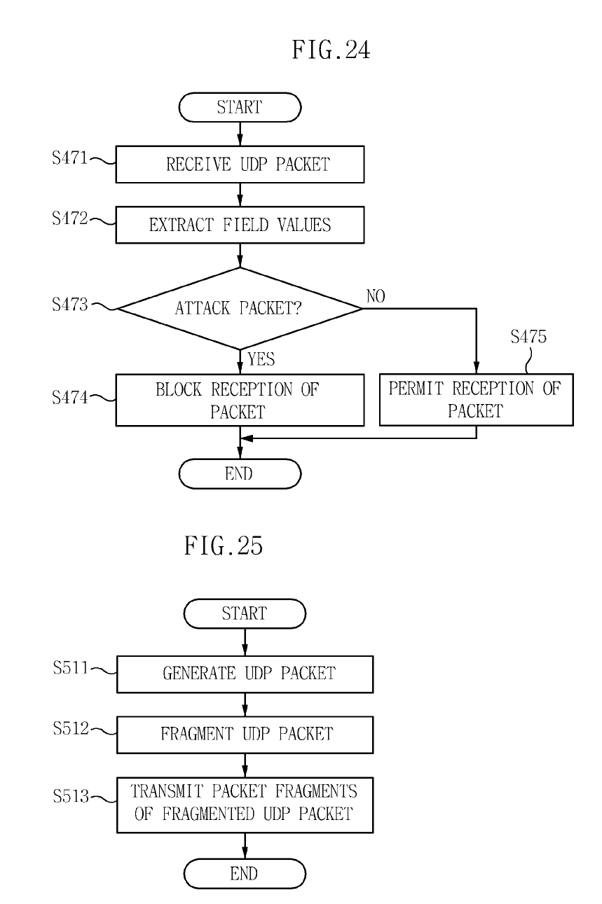

Next, a method in which the server performs filtering on packets using the filtering table according to a fourth embodiment of the present invention will be described with reference to FIG. 24.

FIG. 24 is a flowchart showing a packet filtering method according to a fourth embodiment of the present invention.

As shown in FIG. 24, the server 200 receives a UDP packet P410 from the client 100 at step S471.

The server 200 extracts the field values of a destination address field (Destination Address) P411m and a destination port field (Destination Port) P413b from the received UDP packet P410 at step S472.

Thereafter, the server 200 determines whether the received UDP packet P410 is an attack packet by using the extracted field values of the destination address field P411m and the destination port field P413b at step S473. Here, if the filtering data, including the extracted field values of the destination address field P411m and the destination port field P413b, is stored in a pre-stored filtering table P450, the server 200 can determine the received UDP packet to be an attack packet.

If the received UDP packet P410 is an attack packet, the server 200 blocks the reception of the UDP packet P410 at step S474.

In contrast, if the received UDP packet P410 is not an attack packet, the server 200 permits the reception of the UDP packet P410 at step S475.

Next, a method in which the client makes a DoS attack against the server on the basis of a UDP flooding attack method according to a fifth embodiment of the present invention will now be described in detail with reference to FIG. 25.

FIG. 25 is a flowchart showing a DoS attack method performed by the client according to a fifth embodiment of the present invention.

As shown in FIG. 25, the client 100 generates a UDP packet for a DoS attack against the server 200 at step S511.

The client fragments the generated UDP packet, and then generates a plurality of packet fragments corresponding to the fragmented UDP packet at step S512.

The client 100 transmits the plurality of generated packet fragments to the server 200 at step S513.

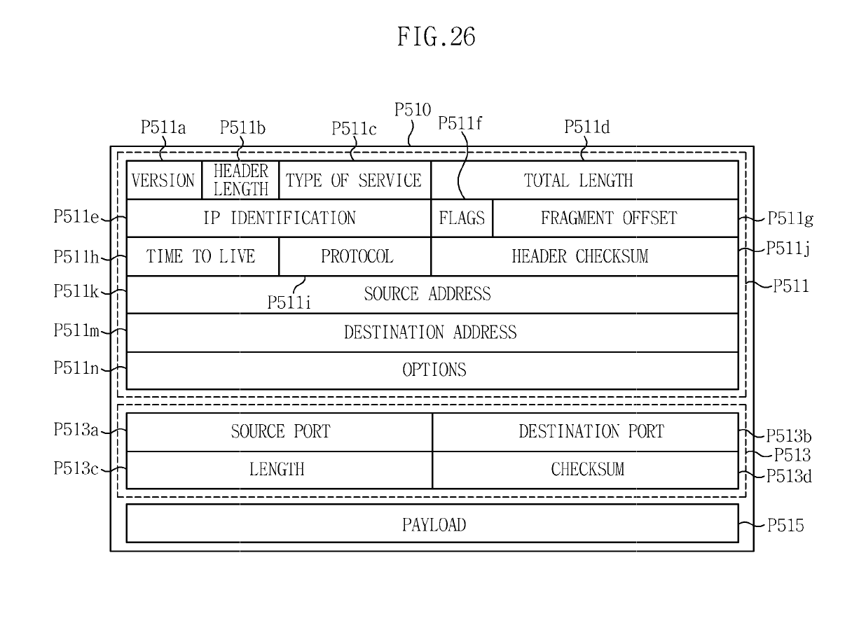

Next, the packet fragment of the fragmented UDP packet according to a fifth embodiment of the present invention will be described with reference to FIG. 26.

FIG. 26 is a diagram showing the structure of a packet fragment according to a fifth embodiment of the present invention.

As shown in FIG. 26, a packet fragment P510 includes an IP header P511, a UDP header P513, and a payload P515.

The IP header P511 includes a version field (Version) P511a, a header length field (Header Length) P511b, a service type field (Type of Service) P511c, a packet length field (Total Length) P511d, an IP identification field (IP Identification) P511e, a flag field (Flags) P511f, a fragment offset field (Fragment Offset) P511g, a packet duration field (Time To Live) P511h, a protocol identification field (Protocol) P511i, a header checksum field (Header Checksum) P511j, a source address field (Source Address) P511k, a destination address field (Destination Address) P511m, and an option field (Options) P511n.

The version field (Version) P511a includes a field value indicating the version of an Internet protocol (IP).

The header length field (Header Length) P511b includes a field value indicating the length of the IP header P511.

The service type field (Type of Service) P511c includes a field value indicating the required service quality.

The packet length field (Total Length) P511d includes a field value indicating the total length of a relevant packet fragment.

The ID identification field (IP Identification) P511e includes a field value indicating the identification information of the IP header P511 of the relevant packet fragment.

The flag field (Flags) P511f includes a field value indicating fragmentation information about the relevant packet fragment. Here, when the relevant packet fragment is not the last packet fragment of the fragmented UDP packet, the flag field (Flags) P511f may have a field value of “0x1” indicating “More Fragments.”

The fragment offset field (Fragment Offset) P511g includes a field value indicating the location of the relevant packet fragment.

The packet duration field (Time To Live) P511h includes a field value indicating the packet duration required to determine whether to discard the relevant packet fragment.

The protocol identification field (Protocol) P511i includes a field value indicating the protocol of the relevant packet fragment. Here, when the relevant packet fragment conforms to a UDP, the protocol identification field (Protocol) P511i may have a field value of “0x11.”

The header checksum field (Header Checksum) P511j includes a field value required to detect errors in the IP header P511.

The source address field (Source Address) P511k includes a field value indicating the IP address of a source.

The destination address field (Destination Address) P511m includes a field value indicating the IP address of a destination.

The option field (Options) P511n includes a field value indicating the selection option of the IP header P511.

The UDP header P513 includes a source port field (Source Port) P513a, a destination port field (Destination Port) P513b, a data length field (Length) P513c, and a checksum field (Checksum) P513d.

The source port field (Source Port) P513a includes a field value indicating the port number of the source.

The destination port field (Destination Port) P513b includes a field value indicating the port number of the destination.

The data length field (Length) P513c includes a field value indicating the length of the payload P515.

The checksum field (Checksum) P513d includes a field value required to detect errors in the UDP header P513.

The payload P515 includes any type of data.

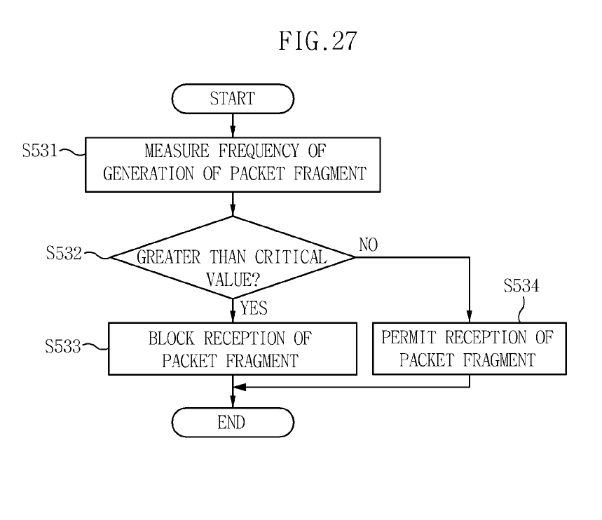

Next, a method in which the server blocks a DoS attack made by the client according to a fifth embodiment of the present invention will be described with reference to FIG. 27.

FIG. 27 is a flowchart showing a method for blocking a DoS attack according to a fifth embodiment of the present invention.

As shown in FIG. 27, the server 200 measures the frequency of the generation of a packet fragment, in which the field value of a protocol identification field P511i is “0x11” and the field value of the flag field (Flags) P511f is “0x1”, at step S531. Here, the server 200 can measure the frequency of the generation of the packet fragment per second for each destination address. That is, the server 200 can measure the quantity of the packet fragments that are received for a predetermined period of time.

The server 200 compares the measured generation frequency with a preset critical value, and then determines whether the measured generation frequency is greater than the critical value at step S532.

If it is determined that the measured generation frequency is greater than the critical value, the server 200 blocks the reception of the relevant packet fragment at step S533.

In contrast, if it is determined that the measured generation frequency is not greater than the critical value, the server 200 permits the reception of the packet fragment at step S534.

According to the characteristics of the present invention, the following advantages can be expected.

The present invention provides a method of classifying the types of UDP flooding attack, and detecting and blocking attack packets depending on the characteristics of the respective attack types, so that only the behavior of malicious users is blocked for various types of UDP flooding, thus enabling network services to be smoothly provided to proper users.

As described above, optimal embodiments of the present invention have been disclosed in the drawings and the present specification. In this case, although specific terms have been used, those terms are merely intended to describe the present invention and are not intended to limit the meanings and the scope of the present invention as disclosed in the accompanying claims. Therefore, those skilled in the art will appreciate that various modifications and other equivalent embodiments are possible from the above-description. Therefore, the technical scope of the present invention should be defined by the technical spirit of the accompanying claims.

What is claimed is:

1. A method for blocking a Denial-of-Service (DoS) attack based on User Datagram Protocol (UDP) flooding, comprising:
extracting a plurality of suspicious packets including data, length of which is equal to or greater than a preset length, from a plurality of received packets;
determining a packet, which includes data composed of characters or character strings identical to each other, among the plurality of suspicious packets, to be an attack packet; and
blocking a packet corresponding to the attack packet.

2. The method of claim 1, wherein the plurality of received packets are transmitted/received using User Datagram Protocol (UDP).

3. The method of claim 2, wherein the extracting is configured to extract the plurality of suspicious packets from the plurality of received packets using data length information included in each of the plurality of received packets.

4. The method of claim 1, wherein the determining is configured to determine a packet, which includes data composed of characters identical to each other, among the plurality of suspicious packets, to be an attack packet.

5. The method of claim 1, wherein the determining comprises:
detecting a plurality of attack packets, which include data composed of character strings identical to each other, from the plurality of suspicious packets; and
generating filtering data for the plurality of attack packets.

6. The method of claim 5, wherein the generating comprises:
generating hash values by applying the data, which is composed of character strings identical to each other and is included in each of the plurality of attack packets, to a hash function; and
generating filtering data including the hash values and data length information of the data composed of character strings identical to each other.

7. The method of claim 6, wherein the blocking is configured to block a packet corresponding to the filtering data.

8. A method for blocking a Denial-of-Service (DoS) attack based on User Datagram Protocol (UDP) flooding, comprising:
determining whether a plurality of received packet fragments include data composed of characters identical to each other;
if it is determined that the plurality of packet fragments include the data composed of characters identical to each other, configuring a filtering table that includes filtering data by using header information of each of the plurality of packet fragments; and
blocking a packet fragment corresponding to the filtering data using the filtering table.

9. The method of claim 8, wherein the plurality of packet fragments are transmitted/received using User Datagram Protocol (UDP).

10. The method of claim 9, wherein the configuring comprises:
extracting Internet Protocol (IP) identification information from any one of the plurality of packet fragments; and
generating filtering data including the IP identification information.

11. The method of claim 10, wherein the blocking is configured to block a packet fragment corresponding to the IP identification information included in the filtering data.

12. The method of claim 8, further comprising:
if it is determined that the plurality of packet fragments do not include data composed of characters identical to each other, determining whether to block packet fragments that are received by the server, based on the quantity of packet fragments that are received for a predetermined period of time.

13. The method of claim 12, wherein the determining comprises:
comparing the quantity of packet fragments with a preset critical value; and
if the quantity of packet fragments is greater than the critical value, blocking packet fragments that are received by the server.

14. A method for blocking a Denial-of-Service (DoS) attack based on User Datagram Protocol (UDP) flooding, comprising:
if a destination port of a received packet is closed, generating a response message corresponding to the packet so as to indicate that the packet cannot be transferred to the destination port;
extracting destination address information and destination port information from the packet;
generating filtering data including the destination address information and the destination port information; and
blocking an attack packet that includes the destination address information and the destination port information by using the filtering data.

15. The method of claim 14, wherein a protocol of the packet is User Datagram Protocol (UDP).

16. The method of claim 15, wherein the extracting is configured to extract the destination address information and the destination port information if the response message includes an error message.

17. The method of claim 16, wherein a protocol of the response message is Internet Control Message Protocol (ICMP).

18. The method of claim 17, wherein the response message has a message type which is a destination unreachable type.
